(19) United States
(12) Patent Application Publication
(10) Pub. No.: US 2026/0000183 A1
(43) Pub. Date: Jan. 1, 2026

(54) MAKEUP APPLICATOR COMPRISING PROTRUSIONS

(71) Applicant: Love Your Freckles LLC, Southold, NY (US)

(72) Inventors: Alexandra Roselanne Becker, Southold, NY (US); Charles Zaloom, IV, New York, NY (US)

(73) Assignee: Love Your Freckles LLC, Southold, NY (US)

(21) Appl. No.: 19/253,608

(22) Filed: Jun. 27, 2025

Related U.S. Application Data
(60) Provisional application No. 63/666,126, filed on Jun. 29, 2024.

(51) Int. Cl. A45D 33/34; B33Y 80/00

(52) U.S. Cl. CPC A45D 33/34; B33Y 80/00

(57) ABSTRACT

Devices and methods for applying makeup to skin are generally provided. In some embodiments, the devices and methods disclosed herein may be used to apply makeup to skin in a pattern that mimics a natural arrangement of freckles or other pigment irregularities of the skin. In some embodiments, the appearance of pigment irregularities such as those that mimic naturally occurring arrangements of freckles may be desirable, based on the aesthetic preferences of a user. Advantageously, the devices and methods disclosed herein may allow for the application of makeup to the skin in a pattern that looks similar to (e.g., mimics) naturally occurring arrangements of freckles. Without wishing to be bound by a particular theory, it is believed that several features of the disclosed devices (e.g., variations in the height and/or spacing of protrusions configured to mimic an arrangement of freckles, as described in greater detail below) may accurately mimic the variations in size and spacing found in naturally occurring arrangements of freckles. The methods as described herein may also allow for a user to control the level of pigmentation, shape, and/or spacing of deposits of makeup transferred to the skin, which is believed to also allow for the accurate mimicking of variations of size, shape, and pigmentation levels in naturally occurring arrangements of freckles.

### RELATED APPLICATIONS

This application claims priority under 35 U.S.C. § 119(e) to U.S. Provisional Patent Application No. 63/666,126, filed Jun. 29, 2024, and entitled “Freckle Stamp,” which is incorporated herein by reference in its entirety for all purposes.

### FIELD

Devices and methods for applying makeup to the skin in a pattern that mimics an arrangement of freckles are described.

### BACKGROUND

In some applications, it may be desirable to apply makeup to the skin in a pattern that mimics a natural arrangement of freckles. However, some devices and methods for applying makeup to the skin do not allow for the user-friendly application of makeup in a way that mimics an arrangement of freckles.

Accordingly, new devices and methods would be beneficial.

### SUMMARY

The present disclosure generally describes devices and methods. The subject matter described herein involves, in some cases, interrelated products, alternative solutions to a particular problem, and/or a plurality of different uses of one or more devices and/or articles.

In some embodiments, a device is provided. The device comprises a base portion comprising a surface; and a plurality of protrusions disposed on the surface of the base portion, wherein: each protrusion in the plurality of protrusions comprises a face, an average height of the plurality of protrusions is greater than or equal to 1 mm and less than or equal to 2 mm, and an average spacing between the protrusions is greater than or equal to 2 mm.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 depicts a non-limiting device comprising base portion and a plurality of protrusions, according to some embodiments;

FIG. 2 is a flowchart depicting a non-limiting example of a method, according to some embodiments;

FIG. 3 depicts a non-limiting base portion of a device, the base portion having a circular cross-section, according to some embodiments;

FIG. 4 depicts a non-limiting base portion of a device, the base portion comprising a surface, according to some embodiments

FIG. 5A depicts a non-limiting base portion of a device, the base portion comprising a flat surface, according to some embodiments

FIG. 5B depicts a non-limiting base portion of a device, the base portion comprising a curved surface, according to some embodiments;

FIG. 6A depicts a non-limiting top-view schematic of a device comprising a plurality of protrusions with a relatively high average spacing, according to some embodiments;

FIG. 6B depicts a non-limiting top-view schematic of a device comprising a plurality of protrusions with a relatively low average spacing, according to some embodiments;

FIG. 7A depicts a device comprising a plurality of protrusions with a relatively uniform height, according to some embodiments;

FIG. 7B depicts a device comprising a plurality of protrusions with a relatively non-uniform height, according to some embodiments;

FIG. 7C depicts a device comprising a base portion with a curved surface and a plurality of protrusions with a relatively non-uniform height, according to some embodiments;

FIG. 7D depicts a device comprising a plurality of protrusions having a variety of orientations to a surface of a base portion of the device, according to some embodiments;

FIG. 8 depicts a top-view schematic of a device comprising a plurality of protrusions having a variety of diameters, according to some embodiments;

FIG. 9 depicts protrusions having a variety of shapes, according to some embodiments;

FIG. 10 depicts a plurality of protrusions bending during contact with skin, according to some embodiments;

FIG. 11 depicts a casing configured to contain at least a portion of base portion of a device, according to some embodiments;

FIG. 12 depicts a casing containing a portion of a base portion of a device, according to some embodiments;

FIG. 13 depicts a device comprising a casing and a base portion of a device co-formed from a single material, according to some embodiments;

FIGS. 14A-14B depict deposits transferred to skin from a plurality of protrusions, according to some embodiments;

FIG. 15 depicts a device comprising a plurality of protrusions, according to some embodiments;

FIG. 16 depicts a top-view schematic of a device comprising protrusions of different diameters; according to some embodiments;

FIG. 17 depicts protrusions having a variety of heights, according to some embodiments;

FIG. 18 depicts a plurality of protrusions bending during contact with skin, according to some embodiments;

FIG. 19 depicts a device comprising a plurality of protrusions having a variety of orientations to a surface of a base portion of the device, according to some embodiments;

FIG. 20 depicts protrusions having a variety of shapes, according to some embodiments;

FIG. 21 depicts a device comprising a casing and a base portion of a device co-formed from a single material, according to some embodiments;

FIG. 22 depicts a casing containing a portion of a base portion of a device, according to some embodiments;

FIG. 23 depicts a casing containing a portion of a base portion of a device, according to some embodiments; and

FIG. 24 depicts a casing containing a portion of a plurality of protrusions, according to some embodiments.

### DETAILED DESCRIPTION

Devices and methods for applying makeup to skin are generally provided. In some embodiments, the devices and methods disclosed herein may be used to apply makeup to skin in a pattern that mimics a natural arrangement of freckles or other pigment irregularities of the skin. In some embodiments, the appearance of pigment irregularities such as those that mimic naturally occurring arrangements of freckles may be desirable, based on the aesthetic preferences of a user. Advantageously, the devices and methods disclosed herein may allow for the application of makeup to the skin in a pattern that looks similar to (e.g., mimics) naturally occurring arrangements of freckles. Without wishing to be bound by a particular theory, it is believed that several features of the disclosed devices (e.g., variations in the height and/or spacing of protrusions configured to mimic an arrangement of freckles, as described in greater detail below) may accurately mimic the variations in size and spacing found in naturally occurring arrangements of freckles. The methods as described herein may also allow for a user to control the level of pigmentation, shape, and/or spacing of deposits of makeup transferred to the skin, which is believed to also allow for the accurate mimicking of variations of size, shape, and pigmentation levels in naturally occurring arrangements of freckles.

The devices and methods described herein have several other benefits and advantages. For example, the devices and methods disclosed may advantageously be configured to use and/or capable of using any of a variety of suitable makeup products to mimic an arrangement of freckles. This may advantageously allow for a user to select an appropriate product type and/or shade according to their preference.

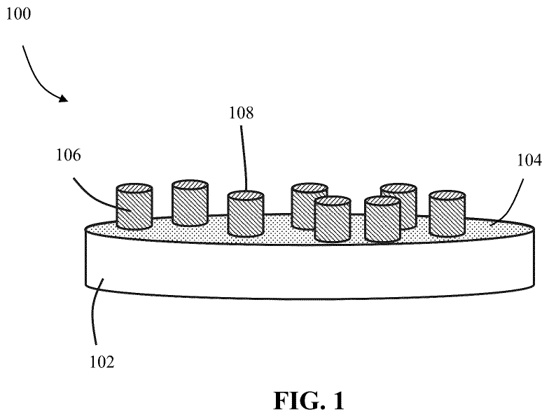

In some embodiments, a device for applying makeup to skin is provided. One non-limiting embodiment of such a device is shown in FIG. 1 as the device 100. In some embodiments, the device may comprise a base portion (e.g., the base portion 102 of the device shown in FIG. 1). In some embodiments, the base portion of the device comprises a surface, such as the surface 104 of the device 100 shown in FIG. 1. In some embodiments, as shown in FIG. 1, the device comprises a plurality of protrusions 106 disposed on the surface 104 of the base portion 102. In some embodiments, each of the protrusions 106 comprises a face 108. The base portion and surface thereof and the plurality of protrusions and faces thereof may have a variety of features and/or characteristics, which are described in detail below.

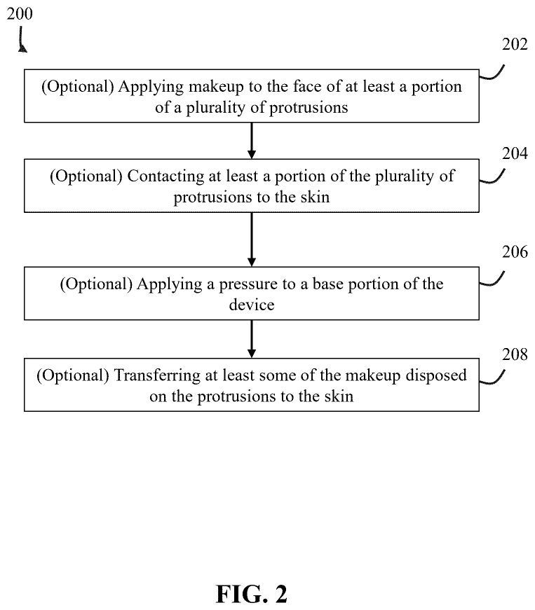

In some embodiments, methods for applying makeup to the skin are provided. A flow chart of one non-limiting example of such a method is shown in FIG. 2 as the method 200. In some embodiments, as shown in the step 202 of the method 200, the method 200 may comprise applying makeup to the face of at least a portion of a plurality of protrusions (e.g., the plurality of protrusions of a device as described above). In some embodiments, the makeup applied to the faces of the plurality of protrusions is thus disposed thereon.

In some embodiments, as shown in the step 204, the method 200 may comprise contacting at least a portion of the plurality of protrusions to the skin. In some embodiments, as shown in the step 206, the method 200 may comprise applying a pressure to a base portion of the device (e.g., the base portion of the device on which the plurality of protrusions is disposed). In some embodiments, applying the pressure to the base portion of the device may be performed while at least a portion of the plurality of protrusions is in contact with the skin.

In some embodiments, as shown in the step 208, method 200 may comprise transferring at least some of the makeup disposed on the protrusions to the skin (e.g., to form deposits). In some embodiments, applying pressure to the base portion of the device may cause at least a portion of the makeup disposed on the plurality of protrusions to be transferred to the skin.

It should be understood that each of the steps shown in FIG. 2 is optional, and the performance of a method as described herein may comprise performing all, some, or none of the steps shown in FIG. 2, in any order.

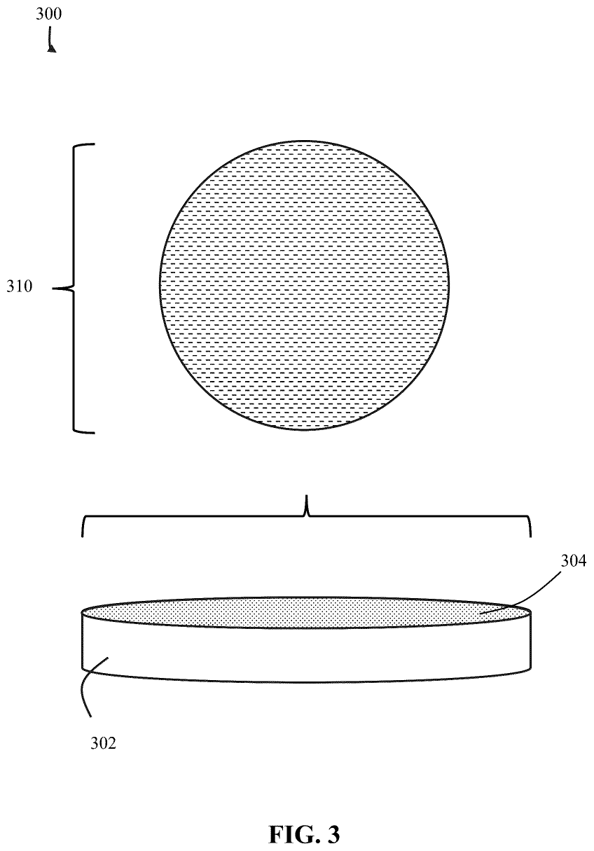

As noted above, in some embodiments, a device as described herein comprises a base portion. The base portion may have any of a variety of suitable cross-sections. For example, in some embodiments, the base portion has a horizontal cross-section having a substantially circular shape. FIG. 3 shows one example of a device 300 comprising a base portion 302 having a surface 304, where a horizontal cross-section 310 of the base portion is substantially circular in shape.

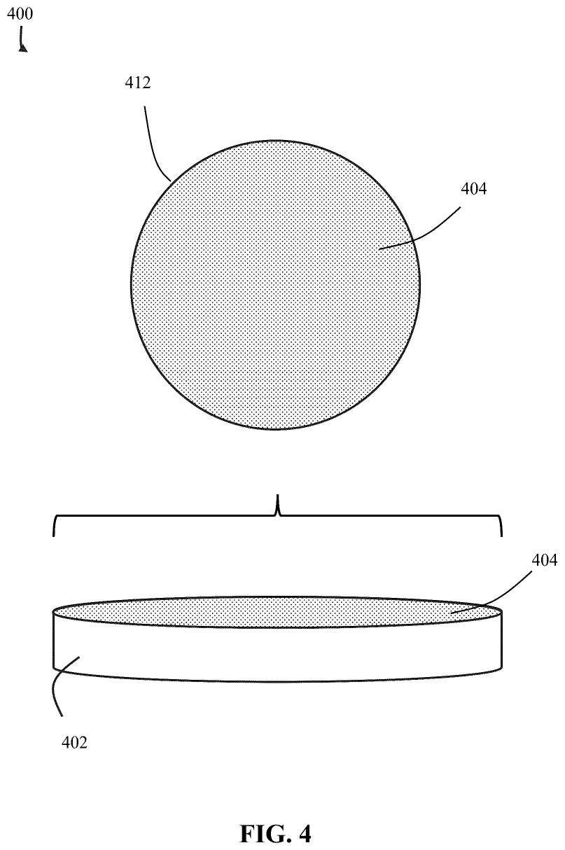

In some embodiments, as noted above, a base portion of a device comprises a surface. The surface of the base portion may have an edge defined by the outer perimeter of the surface. For example, as shown in FIG. 4, a device 400 may comprise a base portion 402 comprising a surface 404 having an edge 412, which is defined by the outer perimeter of the surface 404. In some embodiments, as shown in FIG. 4, the edge 412 defined by the outer perimeter of the surface 404 may be substantially circular in shape. In some embodiments, a base portion with an edge that is substantially circular in shape (e.g., as shown in FIG. 4) may be a base portion with a horizontal cross-section having a substantially circular shape (e.g., as shown in FIG. 3).

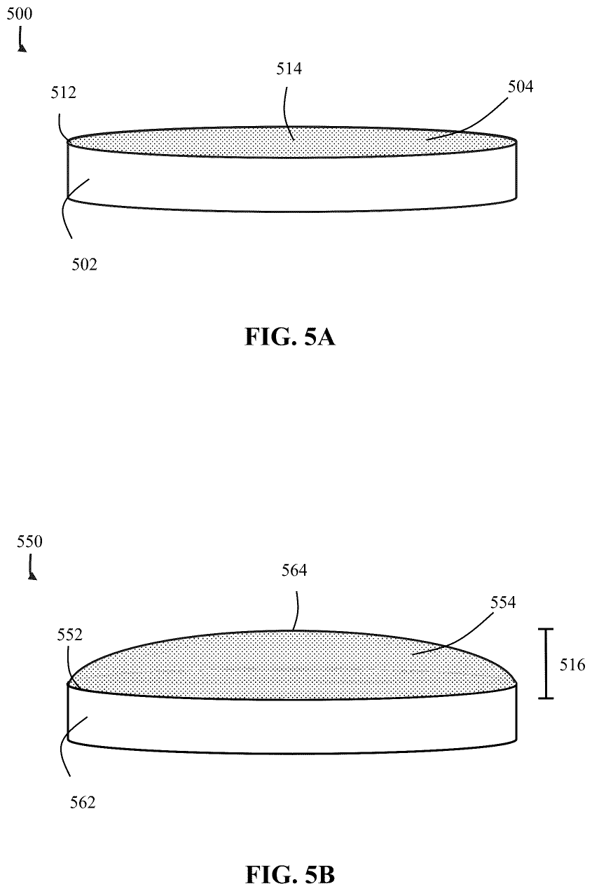

In some embodiments, a base portion may have a surface that is substantially flat. For example, as shown in FIG. 5A, in some embodiments in which a base portion 502 of a device 500 comprises a surface 504 having an edge 512 defined by the outer perimeter of the surface (e.g., an edge defined by a substantially circular outer perimeter as described above), a point at the center of the surface (e.g., the point 514 at the center of the surface 504 shown in FIG. 5A) may be at a similar height as the edge of the surface. For example, in some embodiments, the point at the center of the surface may have a height that differs by greater than or equal to 0 mm, greater than or equal to 0.05 mm, greater than or equal to 0.1 mm, greater than or equal to 0.15 mm, greater than or equal to 0.2 mm, greater than or equal to 0.25 mm, greater than or equal to 0.3 mm, greater than or equal to 0.35 mm, or greater than or equal to 0.4 mm from an average height of the edge of the surface. In some embodiments, the point at the center of the surface may differ by less than 0.45 mm, less than or equal to 0.4 mm, less than or equal to 0.35 mm, less than or equal to 0.3 mm, less than or equal to 0.25 mm, less than or equal to 0.2 mm, less than or equal to 0.15 mm, less than or equal to 0.1 mm, or less than or equal to 0.05 mm from the average height of the edge of the surface. Combinations of these ranges are also possible (e.g., the point at the center of the surface may have a height that differs by greater than or equal to 0 mm and less than 0.45 mm from an average height of the edge of the surface, or greater than or equal to 0 mm and less than or equal to 0.4 mm from an average height of the edge of the surface). Other ranges are also possible.

In some embodiments, a point at the center of the surface of the base portion has a height that is lower than the average height of the edge of the surface (i.e., such that the surface is concave) and differs from the average height of the edge of the surface in one or more of the above-referenced ranges.

In some embodiments, a base portion may have a surface that is curved. For example, as shown in FIG. 5B, in some embodiments in which a base portion 552 of a device 550 comprises a surface 554 having an edge 562 defined by the outer perimeter of the surface (e.g., an edge defined by a substantially circular outer perimeter as described above), the surface may have a curvature such that a point at the center of the surface (e.g., the point 564 at the center of the surface 554 as shown in FIG. 5B) is higher than the edge of the surface (e.g., as shown by the height difference 516 in FIG. 5B). For example, in some embodiments, the surface of the base portion may have a curvature such that a point at the center of the surface has a height that differs by greater than or equal to 0.45 mm, greater than or equal to 0.5 mm, greater than or equal to 0.55 mm, greater than or equal to 0.6 mm, greater than or equal to 0.65 mm, greater than or equal to 0.7 mm, greater than or equal to 0.75 mm, greater than or equal to 0.8 mm, greater than or equal to 0.85 mm, or greater than or equal to 0.9 mm from the average height of the edge of the surface. In some embodiments, the surface of the base portion may have a curvature such that a point at the center of the surface has a height that differs by less than or equal to 0.95 mm, less than or equal to 0.9 mm, less than or equal to 0.85 mm, less than or equal to 0.8 mm, less than or equal to 0.75 mm, less than or equal to 0.7 mm, less than or equal to 0.65 mm, less than or equal to 0.6 mm, less than or equal to 0.55 mm, or less than or equal to 0.5 mm from an average height of the edge of the surface. Combinations of these ranges are also possible (e.g., the surface of the base portion may have a curvature such that a point at the center of the surface has a height that differs by greater than or equal to 0.45 mm and less than or equal to 0.95 mm from the average height of the edge of the surface, or greater than or equal to 0.5 mm and less than or equal to 0.9 mm from the average height of the edge of the surface). Other ranges are also possible. In some embodiments, a point at the center of the surface of the base portion has a height that is higher than the average height of the edge of the surface (i.e., such that the surface is convex) and differs from the average height of the edge of the surface in one or more of the above-referenced ranges.

In some embodiments, a point at the center of the surface of the base portion has a height that is lower than the average height of the edge of the surface (i.e., such that the surface is concave) and differs from the average height of the edge of the surface in one or more of the above-referenced ranges.

As discussed above, in some embodiments a device as described herein may comprise a plurality of protrusions disposed on a surface of a base portion of the device. In some embodiments, the protrusions may be arranged to mimic an arrangement of freckles on skin (e.g., the protrusions may be arranged such that, when makeup deposited on the face of the protrusions is transferred to the skin, the makeup mimics an arrangement of freckles on the skin). Various aspects (e.g., aspects of the arrangement and/or geometry) of the protrusions may allow for the protrusions to mimic an arrangement of freckles on skin. For example, as described in more detail below, various aspects of the arrangement and/or geometry of the protrusions may be configured to mimic and/or capable of mimicking the irregularity (e.g., irregularity in shape, irregularity in spacing, and/or irregularity in pigmentation) associated with naturally-occurring arrangements of freckles.

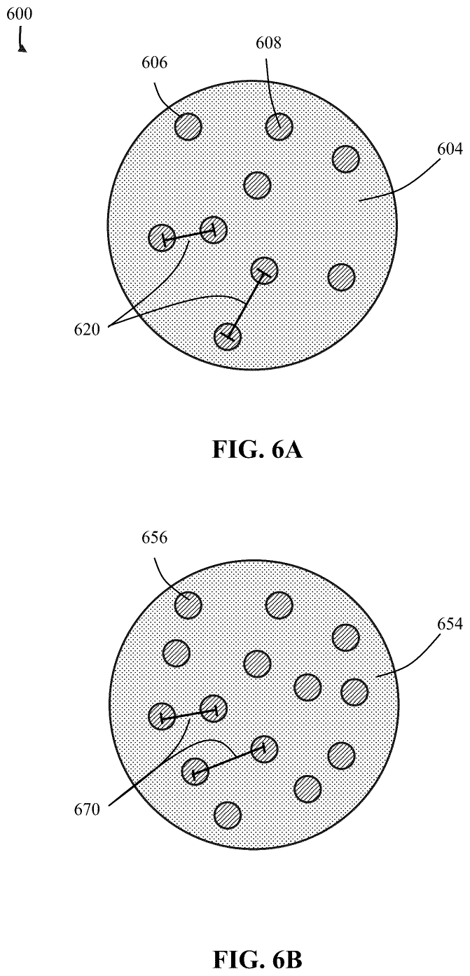

In some embodiments, protrusions of a device as described herein may have any of a variety of suitable spacings. In some embodiments, the spacing between two protrusions of the device (e.g., the spacing between a first protrusion and a second protrusion of the device) may be a nearest-neighbor spacing of the protrusions. In some embodiments, the spacing between two protrusions (e.g., the nearest-neighbor spacing between a first protrusion and a second protrusion) may be measured from the center of one protrusion to a center of another protrusion (e.g., from the center of a first protrusion to the center of another protrusion). In some embodiments, the protrusions are not spaced evenly across a surface of a device as described herein (e.g., the spacing between the protrusions may vary across the plurality of protrusions). For example, as shown in FIG. 6A, a device 600 may comprise a plurality of protrusions 606 disposed on a surface 604, which may be arranged such that there are spacings 620 between the protrusions 606, where not all of the spacings are equal. In some embodiments, as shown in FIG. 6A and described in greater detail below, the plurality of protrusions 606 may be arranged such that the average spacing between the protrusions is relatively high. In some embodiments, as shown in FIG. 6B and described in greater detail below, a device 650 may comprise a plurality of protrusions 656 having spacings 670 that may be arranged such that the average spacing between the protrusions is relatively low.

In some embodiments, the spacing between a first protrusion and a second protrusion in a plurality of protrusions (e.g., a plurality of protrusions disposed on a surface of a device as described herein) may be greater than or equal to 0.25 mm, greater than or equal to 0.5 mm, greater than or equal to 0.75 mm, greater than or equal to 1 mm, greater than or equal to 2.5 mm, greater than or equal to 5 mm, greater than or equal to 7.5 mm, greater than or equal to 10 mm, greater than or equal to 12.5 mm, greater than or equal to 15 mm, or greater than or equal to 17.5 mm. In some embodiments, the spacing between the first protrusion and the second protrusion may be less than or equal to 20 mm, less than or equal to 17.5 mm, less than or equal to 15 mm, less than or equal to 12.5 mm, less than or equal to 10 mm, less than or equal to 7.5 mm, less than or equal to 5 mm, less than or equal to 2.5 mm, less than or equal to 1 mm, less than or equal to 0.75 mm, or less than or equal to 0.5 mm. Combinations of these ranges are also possible (e.g., the spacing between a first protrusion and a second protrusion may be greater than or equal to 0.25 mm and less than or equal to 20 mm, greater than or equal to 0.5 mm and less than or equal to 17.5 mm, or greater than or equal to 0.75 mm and less than or equal to 15 mm). Other ranges are also possible. In some embodiments, a device comprises one or more pairs of protrusions having a spacing that falls within one or more of the above-referenced ranges. In some embodiments, the spacing between each protrusion present in a device and its nearest neighbor falls within one or more of the above-referenced ranges.

In some embodiments, a plurality of protrusions (e.g., in a device as described herein) may comprise protrusions having any of a variety of suitable average spacings. For example, in some embodiments, the protrusions may have an average spacing of greater than or equal to 2 mm, greater than or equal to 3 mm, greater than or equal to 4 mm, greater than or equal to 5 mm, greater than or equal to 7.5 mm, greater than or equal to 10 mm, greater than or equal to 12.5mm, greater than or equal to 15 mm, or greater than or equal to 17.5 mm. In some embodiments, the protrusions may have an average spacing of less than or equal to 20 mm, less than or equal to 17.5 mm, less than or equal to 15 mm, less than or equal to 12.5 mm, less than or equal to 10 mm, less than or equal to 7.5 mm, less than or equal to 5 mm, less than or equal to 4 mm, or less than or equal to 3 mm. Combinations of these ranges are also possible (e.g., the protrusions may have an average spacing of greater than or equal to 2 mm and less than or equal to 20 mm, greater than or equal to 3 mm and less than or equal to 17.5 mm, or greater than or equal to 4 mm and less than or equal to 15 mm). Other ranges are also possible.

In some embodiments, a standard deviation of the spacings between the protrusions of a device may be relatively high. In some embodiments, a relatively high standard deviation between the spacings of the protrusions of the device may indicate that the protrusions are spaced relatively irregularly. For example, in some embodiments, the spacings between the protrusions are substantially random. In some embodiments, the spacings between the protrusions are not substantially regular. For example, in some embodiments, the protrusions are not placed on a grid (e.g., positioned such that each protrusion in the plurality of protrusions may be mapped to a position on a grid). In some embodiments, the spacings between the protrusions do not form a lattice, quasicrystal, or any other regular or semi-regular arrangement. In some embodiments, the spacing between a first protrusion and a second protrusion in the plurality of protrusions may not be correlated to the spacing between any other protrusions of the plurality of protrusions. A relatively irregular spacing of protrusions may advantageously allow for the more accurate and/or realistic mimicking of an arrangement of freckles on the skin by mimicking the irregular spacing of naturally occurring arrangements of freckles.

In some embodiments, a spacing of protrusions of a device as described herein may have a standard deviation of greater than or equal to 0 mm, greater than or equal to 0.25 mm, greater than or equal to 0.5 mm, greater than or equal to 0.75 mm, greater than or equal to 1 mm, greater than or equal to 2 mm, greater than or equal to 3 mm, greater than or equal to 4 mm, greater than or equal to 5 mm, greater than or equal to 6 mm, greater than or equal to 7 mm, greater than or equal to 8 mm, or greater than or equal to 9 mm. In some embodiments, the spacing of the protrusions may have a standard deviation of less than or equal to 10 mm, less than or equal to 9 mm, less than or equal to 8 mm, less than or equal to 7 mm, less than or equal to 6 mm, less than or equal to 5 mm, less than or equal to 4 mm, less than or equal to 3 mm, less than or equal to 2 mm, less than or equal to 1 mm, less than or equal to 0.75 mm, less than or equal to 0.5 mm, less than or equal to 0.25 mm, or less than or equal to 0.1 mm. Combinations of these ranges are also possible (e.g., the spacing of the protrusions may have a standard deviation of greater than or equal to 0 mm and less than or equal to 10 mm, or greater than or equal to 0.1 mm and less than or equal to 9 mm). Other ranges are also possible.

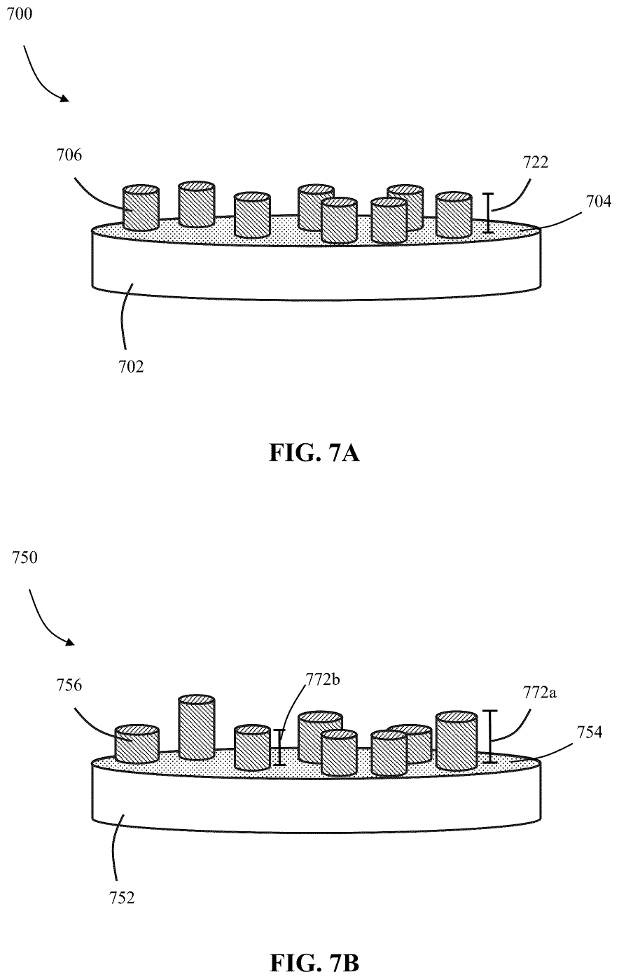

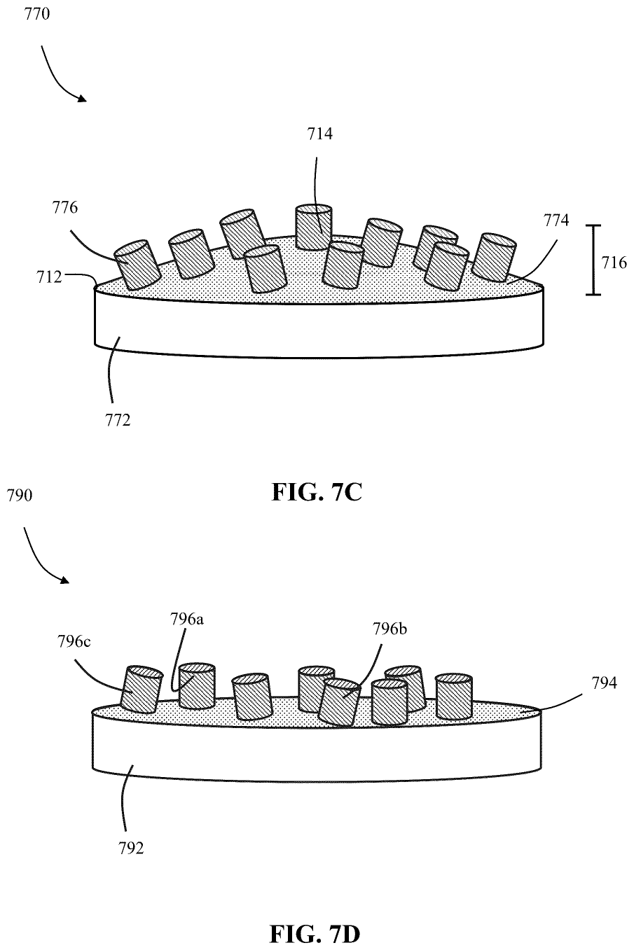

In some embodiments, protrusions of a device as described herein may have any of a variety of suitable heights. For example, as shown in FIG. 7A, a device 700 may comprise a plurality of protrusions 706 disposed on the surface 704 of a base portion 702. In some embodiments, the heights of the protrusions in the plurality of protrusions may be relatively uniform. For example, in the embodiment shown in FIG. 7A, at least some of the plurality of protrusions may have a height 722. In some embodiments, as shown in FIG. 7B, a device 750 may comprise a plurality of protrusions 756 disposed on the surface 757 of a base portion 752. In some embodiments, the heights of the protrusions 756 are not uniform. For example, as shown in FIG. 7B, at least a portion of the protrusions may have a first height 772a, and at least a portion of the protrusions may have a second height 772b. The protrusions may have any of a variety of suitable combinations of heights (e.g., each protrusion in the plurality of protrusions may have a different height, or different distinct pluralities of protrusions within the plurality of protrusions may have different heights).

In some embodiments, the average height of the protrusions may be relatively low. In some embodiments, it may be advantageous for the protrusions to have relatively small heights. For example, in some embodiments and without wishing to be bound by a particular theory, it is believed that protrusions with smaller heights may be easier to manufacture (e.g., less prone to manufacturing error) than protrusions with larger heights. Protrusions with smaller heights may also be advantageous in the use of the device, for example by minimizing the bending of the protrusions when contacted with skin or allowing for a particularly desirable amount of bending when the protrusions are contacted with the skin. In some embodiments, the protrusions having relatively small heights may also facilitate easy, low-hassle cleaning of the device.

In some embodiments, protrusions of a device may have an average height of greater than or equal to 1 mm, greater than or equal to 1.1 mm, greater than or equal to 1.2 mm, greater than or equal to 1.3 mm, greater than or equal to 1.4 mm, greater than or equal to 1.5 mm, greater than or equal to 1.6 mm, greater than or equal to 1.7 mm, greater than or equal to 1.8 mm, or greater than or equal to 1.9 mm. In some embodiments, the protrusions of the device may have an average height of less than or equal to 2 mm, less than or equal to 1.9 mm, less than or equal to 1.8 mm, less than or equal to 1.7 mm, less than or equal to 1.6 mm, less than or equal to 1.5 mm, less than or equal to 1.4 mm, less than or equal to 1.3 mm, less than or equal to 1.2 mm, or less than or equal to 1.1 mm. Combinations of these ranges are also possible (e.g., the protrusions may have an average height of greater than or equal to 1 mm and less than or equal to 2 mm, or greater than or equal to 1.1 mm and less than or equal to 1.9 mm). Other ranges are also possible.

The height of protrusions of a device as described herein may have any of a variety of suitable standard deviations. In some embodiments, the height of protrusions of a device as described herein may have a standard deviation of greater than or equal to 0 mm, greater than or equal to 0.1 mm, greater than or equal to 0.25 mm, greater than or equal to 0.5 mm, greater than or equal to 0.75 mm, greater than or equal to 1 mm, greater than or equal to 1.5 mm, greater than or equal to 2 mm, greater than or equal to 2.5 mm, greater than or equal to 3 mm, greater than or equal to 3.5 mm, greater than or equal to 4 mm, or greater than or equal to 4.5 mm. In some embodiments, the height of protrusions may have a standard deviation of less than or equal to 5 mm, less than or equal to 4.5 mm, less than or equal to 4 mm, less than or equal to 3.5 mm, less than or equal to 3 mm, less than or equal to 2.5 mm, less than or equal to 2 mm, less than or equal to 1.5 mm, less than or equal to 1 mm, less than or equal to 0.75 mm, less than or equal to 0.5 mm, less than or equal to 0.25 mm, or less than or equal to 0.1 mm. Combinations of these ranges are also possible (e.g., the height of the protrusions may have a standard deviation of greater than or equal to 0 mm and less than or equal to 5 mm, or greater than or equal to 0.1 mm and less than or equal to 4 mm). Other ranges are also possible.

While FIGS. 7A and 7B show protrusions disposed on a base portion of a device having a substantially flat surface, it should be noted that, as shown in FIG. 7C, a device 770 may comprise protrusions 776 disposed on the surface 774 of a base portion 772 of the device, where the surface 774 has a curvature such that a point 714 at the center of the surface is higher than the average height of the edge 712 of the surface by a height difference of 716.

In some embodiments, one or more protrusions disposed on a surface of a base portion of a device may have any of a variety of suitable orientations with respect to the surface on which they are disposed. For example, as shown in FIG. 7D, a device 790 may comprise protrusions (e.g., the protrusions 796a, 796b, and 796c) disposed on the surface 794 of a base portion 792 of the device, where the surface 794 may or may not have a curvature (e.g., a curvature as described above). In some embodiments, as shown in FIG. 7D, one or more of the protrusions may intersect the surface of the base portion of the device at an angle that is substantially perpendicular thereto (e.g., the protrusion 796a intersects the surface 794 of the base portion 792 of the device 790 at an angle that is substantially perpendicular thereto). In some embodiments, one or more protrusions of the device may be positioned at an angle other than perpendicular with respect to the surface of the base portion of the device (e.g., the protrusions 796b and 796c as shown in FIG. 7D, which are positioned at an angle relative to the surface 794 of the base portion 792 of the device 790).

In some embodiments, each protrusion in a plurality of protrusions of a device described herein comprises a face (e.g., the face 108 of the protrusions 106 shown in FIG. 1). In some embodiments, the face of the protrusions may be the uppermost portion of the protrusion. For example, in some embodiments, the face of the protrusion may be the portion of the protrusion that is visible when viewing a top view of the device In some embodiments, the face of the protrusion may be the portion of the protrusion that it is possible to bring into contact with a surface (e.g., skin) when the device is held adjacent thereto. For example, there may be at least one angle of contact of the device with skin such that the face of the protrusion may contact the skin without undue force. In some embodiments, there exists an angle of contact of the device with skin such that the faces of a majority of the protrusions (e.g., greater than or equal to 50%, greater than or equal to 60%, greater than or equal to 70%, greater than or equal to 80%, greater than or equal to 90%, greater than or equal to 95%, or greater than or equal to 99% of the protrusions) come into contact with the skin. In some embodiments, a face of a protrusion may be the portion of the protrusion that is accessible (e.g., immediately accessible) to a user, for example when viewing the device from a top-view angle or contacting the device to the skin. In some embodiments, the face may be the portion of the protrusion onto which makeup is deposited and from which makeup is transferred to skin (e.g., when the protrusions are contacted to the skin).

In some embodiments, each protrusion in a plurality of protrusions of a device may comprise a face having a particular shape. For example, in some embodiments, each protrusion in the plurality of protrusions may be substantially circular in shape (e.g., the substantially circular protrusion face 608 as shown in the top-view schematic of FIG. 6A). In some embodiments, the faces of the protrusions being substantially circular in shape may advantageously mimic the substantially circular shape of naturally occurring freckles, thereby allowing makeup to be transferred to the skin in a manner that mimics an arrangement of freckles.

In some embodiments, each protrusion in a plurality of protrusions of a device may comprise a face of a certain size (e.g., diameter). For example, the diameter of a face of a protrusion in the plurality of protrusions may be greater than or equal to 0.1 mm, greater than or equal to 0.25 mm, greater than or equal to 0.5 mm, greater than or equal to 0.55 mm, greater than or equal to 0.75 mm, greater than or equal to 1 mm, greater than or equal to 1.1 mm, greater than or equal to 1.25 mm, greater than or equal to 1.5 mm, or greater than or equal to 1.75 mm. In some embodiments, the diameter of a face of a protrusion in the plurality of protrusions may be less than or equal to 2 mm, less than or equal to 1.75 mm, less than or equal to 1.5 mm, less than or equal to 1.25 mm, less than or equal to 1.1 mm, less than or equal to 1 mm, less than or equal to 0.75 mm, less than or equal to 0.55 mm, less than or equal to 0.5 mm, or less than or equal to 0.25 mm. Combinations of these ranges are also possible (e.g., the protrusion may have a diameter of greater than or equal to 0.1 mm and less than or equal to 2 mm, or greater than or equal to 0.55 mm and less than or equal to 1.1 mm). Other ranges are also possible. In some embodiments, a device comprises one or more protrusions that comprise a face that has a diameter falling within one or more of the above-referenced ranges. In some embodiments, all of the protrusions present in a device comprise faces having a diameter that falls within one or more of the above-referenced ranges.

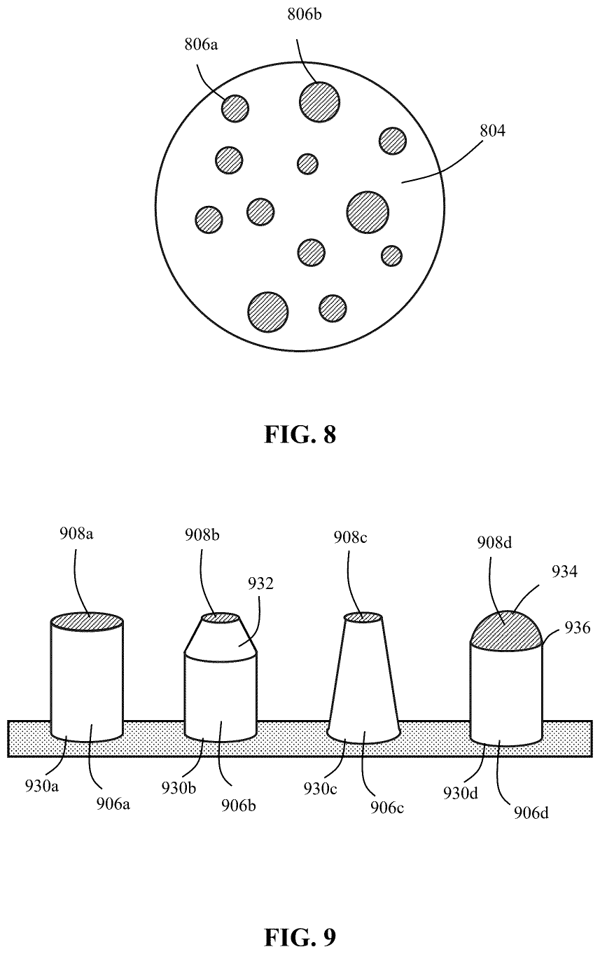

In some embodiments, the faces of the plurality of protrusions may be substantially uniform (e.g., may have a substantially uniform diameter), as shown in the top-view schematic of the device 600 in FIG. 6A. In some embodiments, the faces of the plurality of protrusions may not be substantially uniform (e.g., the diameters of the faces of the protrusions may vary significantly). For example, as seen in the top-view schematic shown in FIG. 8, a device 800 comprises a plurality of protrusions (e.g., the protrusion 806a, the protrusion 806b) disposed on a surface 804 of the device 800. As shown in FIG. 8, the protrusion 806a has a different diameter than the protrusion 806b. Devices comprising protrusions having different diameters are discussed in detail below.

In some embodiments, a device as described herein may comprise a plurality of protrusions wherein a standard deviation of a diameter of a face of the protrusions is relatively high. In some embodiments, a relatively high standard deviation of the diameters of the faces of the protrusions may indicate that faces of the protrusions are relatively irregular in size (e.g., diameter). A relatively irregular size of the faces of the protrusions may advantageously allow for the more accurate and/or realistic mimicking of an arrangement of freckles on the skin by mimicking the irregular sizes of naturally occurring arrangements of freckles.

In some embodiments, the diameters of the faces of protrusions of a device as described herein may have a standard deviation of greater than or equal to 0.04 mm, greater than or equal to 0.05 mm, greater than or equal to 0.055 mm, greater than or equal to 0.06 mm, greater than or equal to 0.065 mm, greater than or equal to 0.07 mm, greater than or equal to 0.075 mm, greater than or equal to 0.08 mm, greater than or equal to 0.085 mm, greater than or equal to 0.09 mm, greater than or equal to 0.095 mm, greater than or equal to 0.1 mm, greater than or equal to 0.15 mm, greater than or equal to 0.2 mm, greater than or equal to 0.25 mm, greater than or equal to 0.3 mm, greater than or equal to 0.35 mm, greater than or equal to 0.4 mm, or greater than or equal to 0.45 mm. In some embodiments, the diameters of the faces of the protrusions may have a standard deviation of less than or equal to 0.5 mm, less than or equal to 0.45 mm, less than or equal to 0.4 mm, less than or equal to 0.35 mm, less than or equal to 0.3 mm, less than or equal to 0.25 mm, less than or equal to 0.2 mm, less than or equal to 0.15 mm, less than or equal to 0.1 mm, less than or equal to 0.095 mm, less than or equal to 0.09 mm, less than or equal to 0.085 mm, less than or equal to 0.08 mm, less than or equal to 0.075 mm, less than or equal to 0.07 mm, less than or equal to 0.065 mm, less than or equal to 0.06 mm, less than or equal to 0.055 mm, less than or equal to 0.05 mm, or less than or equal to 0.045 mm. Combinations of these ranges are also possible (e.g., the diameters of the faces of the protrusions may be greater than or equal to 0.04 mm and less than or equal to 0.5 mm, greater than or equal to 0.05 mm and less than or equal to 0.4 mm, or greater than or equal to 0.065 mm and less than or equal to 0.3 mm). Other ranges are also possible.

A device as described herein may comprise protrusions having any of a variety of suitable shapes. For example, in some embodiments, the protrusions may be substantially columnar, such as the protrusion 906a as shown in FIG. 9. In some embodiments, the diameter of a face of a columnar protrusion (e.g., the face 908a of the protrusion 906a) may have substantially the same diameter as a base portion of the columnar protrusion (e.g., the base portion 930a of protrusion 906a).

In some embodiments, the device may comprise a plurality of protrusions in which one or more of the protrusions comprises a chamfered edge (e.g., the protrusion 906b shown in FIG. 9, having the chamfered edge 930). The protrusion(s) having a chamfered edge may have any of a variety of suitable profiles. For example, a ratio of the diameter of the face of the protrusion(s) (e.g., the diameter of face 908b of protrusion 906b having chamfered edge 932) to the diameter of the base of the protrusion(s) (e.g., base 930b of protrusion 906b) may be greater than or equal to 1/20, greater than or equal to 1/15, greater than or equal to 1/10, greater than or equal to ⅕,greater than or equal to ¼, greater than or equal to ⅓, greater than or equal to ½, greater than or equal to ⅔, greater than or equal to ¾, greater than or equal to ⅘, or greater than or equal to 9/10. In some embodiments, the ratio of the diameter of the face of the protrusion(s) to the diameter of the base of the protrusion(s) is less than 1, less than or equal to 9/10, less than or equal to ⅘, less than or equal to ¾, less than or equal to ⅔, less than or equal to ½, less than or equal to ⅓, less than or equal to ¼, less than or equal to ⅕, less than or equal to 1/10, or less than or equal to 1/15. Combinations of these ranges are also possible (e.g., the ratio of the diameter of the face of the protrusion(s) to the ratio of the diameter of the base of the protrusion(s) is greater than or equal to 1/20 and less than 1, or greater than or equal to 1/15 and less than or equal to 9/10). Other ranges are also possible.

In some embodiments, the device may comprise a plurality of protrusions in which one or more of the protrusions is a tapered protrusion (e.g., the tapered protrusion 906c shown in FIG. 9). The tapered protrusion(s) may have any of a variety of suitable profiles. For example, a ratio of the diameter of the face of the protrusion(s) (e.g., the diameter of face 908c of tapered protrusion 906c) to the diameter of the base of the protrusion(s) (e.g., the base 930c of the tapered protrusion 906c) may be greater than or equal to 1/20, greater than or equal to 1/15,greater than or equal to 1/10, greater than or equal to ⅕, greater than or equal to ¼, greater than or equal to ⅓, greater than or equal to ½, greater than or equal to ⅔, greater than or equal to ¾, greater than or equal to ⅘, or greater than or equal to 9/10. In some embodiments, the ratio of the diameter of the face of the protrusion(s) to the diameter of the base of the protrusion(s) is less than 1, less than or equal to 9/10, less than or equal to 4/5, less than or equal to ¾, less than or equal to ⅔, less than or equal to ½, less than or equal to 1/3, less than or equal to ¼, less than or equal to ⅕, less than or equal to 1/10, or less than or equal to 1/15.Combinations of these ranges are also possible (e.g., the ratio of the diameter of the face of the protrusion(s) to the ratio of the diameter of the face of the protrusion(s) is greater than or equal to 1/20 and less than 1, or greater than or equal to 1/15 and less than or equal to 9/10). Other ranges are also possible.

In some embodiments, each protrusion in a plurality of protrusions of a device may comprise a face having any of a variety of suitable curvatures. For example, in some embodiments, the face of one or more protrusions in the plurality of protrusions may be substantially flat, such as the faces 908a, 908b, and 908c of the protrusions 906a, 906b, and 906c shown in FIG. 9. In some embodiments, the face of one or more protrusions in the plurality of protrusions, such as the protrusion 906d shown in FIG. 9, may have a curved shape such that a center point 934 of the face 908d is higher than an edge 936 of the face (e.g., the face of the protrusion may have a semi-circular profile). In some such embodiments, such as in the protrusion 906d as shown in FIG. 9, the base portion 930d of the protrusion may have substantially the same diameter of the edge 936 of the face 908d of the protrusion.

A device as described herein may comprise a base portion and/or a plurality of protrusions formed from any of a variety of suitable materials. In some embodiments, the base portion and/or the plurality of protrusions may be formed from materials having a variety of advantageous properties. For example, in some embodiments, the materials may be biocompatible, non-toxic, and/or hypoallergenic, which may advantageously reduce the risk of causing irritation when the device is used to apply makeup to the skin. As another example, the material may advantageously be able to be used in 3D printing and/or injection molding manufacturing processes. In some embodiments, the base portion and/or plurality of protrusions may be formed from a material that is biocompatible, non-toxic, hypoallergenic, and compatible with the use of 3D printing and injection molding. In some embodiments, the material may be a polymeric material. In some embodiments, the material is thermoplastic polyurethane.

In some embodiments, a device as described herein may comprise a base portion and a plurality of protrusions that are co-formed from a single material. For example, in some embodiments, the base portion and the plurality of protrusions may be formed from one continuous material such that there is no identifiable material interface between the base portion and the protrusions. In some embodiments, the base portion and the plurality of protrusions are formed separately from the same material or a different material, and the protrusions are disposed on and attached to the base portion (e.g., via chemical bonding, mechanical bonding, an adhesive, etc.). The base portion and the plurality of protrusions may be attached such that they cannot be separated without the use of specialized tools.

In some embodiments, a device as described herein comprises a base portion and/or a plurality of protrusions that are made using any of a variety of suitable manufacturing methods. For example, in some embodiments, the base portion and/or the plurality of protrusions are 3D printed. The base portion and/or the plurality of protrusions may be 3D printed using a variety of techniques, such as material extrusion (e.g., fused filament fabrication, pellet fed/fused-granular fabrication, and/or direct-ink writing) and/or powder-bed fusion of polymers (e.g., selective laser sintering, multi-jet fusion, and/or high-speed sintering). In some embodiments, as described above, the base portion and the plurality of protrusions may be co-formed from a single material via 3D printing. In some embodiments, the base portion and/or the plurality of protrusions may be injection molded. In some embodiments, the base portion and the plurality of protrusions may be co-formed from a single material via injection molding. In some embodiments, the base portion and the plurality of protrusions may be formed separately via 3D printing or injection molding, the plurality of protrusions then disposed on and/or attached to the base portion (e.g., via chemical or mechanical bonding, or an adhesive). In some embodiments, the base portion and/or the plurality of protrusions may be 3D printed and/or injection molded using any of the materials described above (e.g., thermoplastic polyurethane, etc.).

In some embodiments, a device as described herein may comprise a base portion and/or a plurality of protrusions formed from a material that is porous and/or that has a relatively high porosity. For example, in some embodiments, the base portion and/or plurality of protrusions may have a porosity due to the incorporation of air (e.g., air bubbles and/or air pockets) into the material during the manufacturing process (e.g., a 3D printing and/or injection molding manufacturing process as described above). In some embodiments, the base portion and/or the plurality of protrusions having a relatively high porosity may have a variety of advantages. For example, in some embodiments, the plurality of protrusions having a relatively high porosity may advantageously allow for makeup to more strongly adhere to the protrusions (e.g., prior to the transfer of makeup from the protrusions to the skin), thus allowing for a greater quantity of makeup to be transferred to the skin than protrusions formed from a material with a lower porosity.

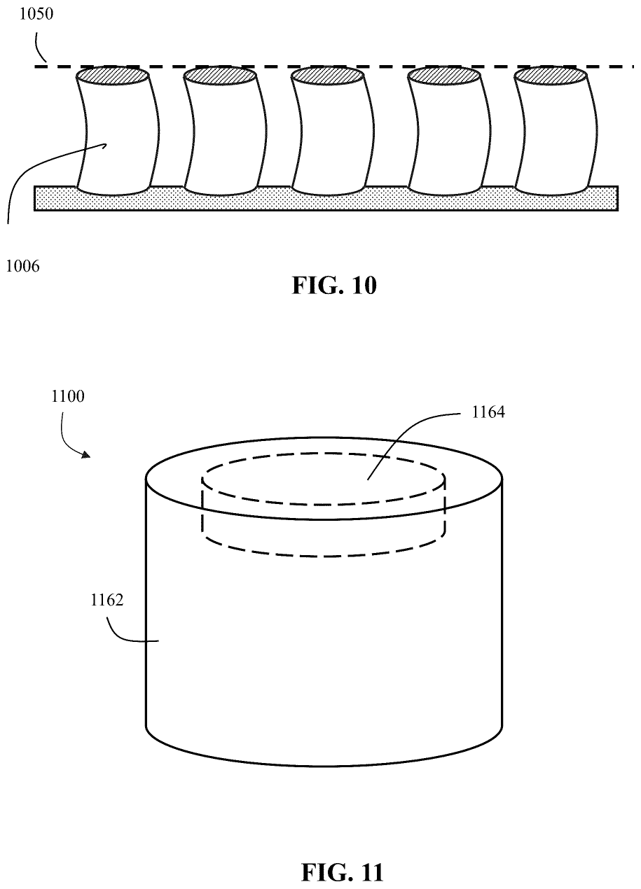

In some embodiments, a device as described herein may comprise a base portion and/or a plurality of protrusions formed from a relatively flexible material. The base portion and/or the plurality of protrusions being formed from a relatively flexible material may have a variety of advantages. For example, the plurality of protrusions being formed from a relatively flexible material may advantageously allow for a greater degree of control and/or variation of the application of makeup to skin using the device. The plurality of protrusions being formed from a relatively flexible material, for example, may advantageously allow the protrusions to bend and/or deform during the transfer of makeup to the skin from the protrusions (for example, shown in FIG. 10, where the protrusions 1006 are bending during contact with the skin 1050). The ability of the protrusions to bend and/or deform during the transfer of makeup to the skin may advantageously allow for a user to modulate the size and/or pigmentation of the deposits of makeup transferred to the skin from the protrusions, for example by applying varying levels of pressure to the device during application, thereby allowing the user to tailor the application of makeup according to their preferences. In some embodiments, the ability to vary the size and/or pigmentation of the deposits of makeup transferred to the skin from the protrusions may allow a user to more easily and/or more accurately apply makeup that mimics an arrangement of freckles (e.g., naturally-occurring freckles) on the skin, as naturally-occurring freckles often vary in size and pigmentation. In some embodiments, the relatively flexible material is still sufficiently rigid such that the protrusions do not bend under their own weight and/or such that they do not substantially collapse upon transfer of makeup to the skin from the protrusions.

In some embodiments, a device may comprise a base portion and/or a plurality of protrusions formed from a relatively flexible material having a modulus at 100% elongation of greater than or equal to 8.7 MPa, greater than or equal to 8.9 MPa, greater than or equal to 9.1 MPa, greater than or equal to 9.3 MPa, greater than or equal to 9.5 MPa, greater than or equal to 9.7 MPa, greater than or equal to 9.9 MPa, greater than or equal to 10.1 MPa, greater than or equal to 10.3 MPa, or greater than or equal to 10.5 MPa. In some embodiments, the relatively flexible material may have a modulus at 100% elongation of less than or equal to 10.7 MPa, less than or equal to 10.5 MPa, less than or equal to 10.3 MPa, less than or equal to 10.1 MPa, less than or equal to 9.9 MPa, less than or equal to 9.7 MPa, less than or equal to 9.5 MPa, less than or equal to 9.3 MPa, less than or equal to 9.1 MPa, or less than or equal to 8.9 MPa.

Combinations of these ranges are also possible (e.g., the flexible material may have a modulus at 100% elongation of greater than or equal to 8.7 MPa and less than or equal to 10.7 MPa, or greater than or equal to 9.1 MPa and less than or equal to 10.1 MPa). In some embodiments, the flexible material has a modulus at 100% elongation of approximately 9.7 MPa.

In some embodiments, a device may comprise a base portion and/or a plurality of protrusions formed from a relatively flexible material having a Shore A hardness of greater than or equal to 90, greater than or equal to 91, greater than or equal to 92, greater than or equal to 93, greater than or equal to 94, greater than or equal to 95, greater than or equal to 96, greater than or equal to 97, greater than or equal to 98, or greater than or equal to 99. In some embodiments, the relatively flexible material has a Shore A hardness of less than or equal to 100, less than or equal to 99, less than or equal to 98, less than or equal to 97, less than or equal to 96, less than or equal to 95, less than or equal to 94, less than or equal to 93, less than or equal to 92, or less than or equal to 91. Combinations of these ranges are also possible (e.g., the relatively flexible material may have a Shore A hardness of greater than or equal to 90 and less than or equal to 100). In some embodiments, the relatively flexible material has a Shore A hardness of 95.

In some embodiments, a device as described herein may comprise a casing configured to support and/or contain at least a portion of a base portion of the device, such as casing 1100 shown in FIG. 11. The casing may be configured to support, may be capable of supporting, and/or may support at least a portion of the base portion of the device in any of a variety of suitable ways. For example, in some embodiments, the casing 1100 comprises a body portion 1162 and a cavity 1164 disposed within the casing configured to hold, capable of holding, and/or that holds the base portion of the device. In some embodiments, the cavity may have dimensions corresponding to the base portion of the device (e.g., the cavity may have a similar diameter and/or depth as the base portion of the device).

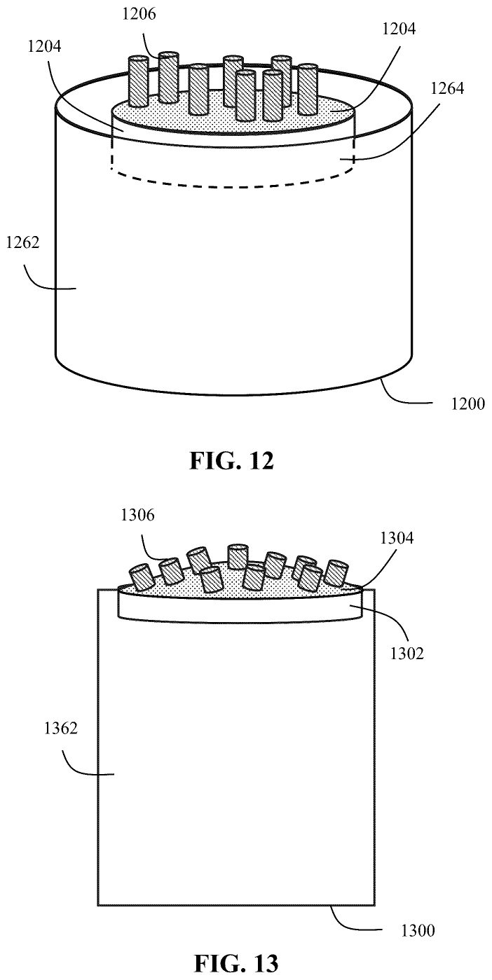

In some embodiments, a base portion of a device may be at least partially contained within a cavity of a casing (e.g., a cavity as described above). For example, as shown in FIG. 12, a base portion 1202 of a device may be at least partially contained within the cavity 1264 within the body portion 1262 of the casing 1200. The base portion of the device may be affixed to the casing (e.g., the cavity of the casing) in any of a variety of suitable ways. For example, in some embodiments, the base portion of the device may be press-fit and/or friction-fit into the cavity of the casing. In some embodiments, the base portion of the device may be secured within the cavity of the casing chemically and/or mechanically. For example, in some embodiments, the base portion of the device may be secured within the cavity of the casing with a glue. As described above, a plurality of protrusions (e.g., plurality of protrusions 1206) having any of the properties and/or characteristics described herein may be disposed on a surface (e.g., surface 1204) of the base portion of the device that is contained within the cavity.

In some embodiments, a base portion and a casing of the device may be co-formed from a single material (e.g., in some embodiments, there may be no identifiable material interface between the base portion and the casing). For example, as shown in FIG. 13, a device may comprise a casing 1300 comprising a body portion 1362 that is co-formed from a single material with a base portion 1302 comprising a surface 1304 and protrusions 1306.

In some embodiments, a device as described herein may further comprise a lid. In some embodiments, the lid may be configured to join to and/or mate with a casing of the device (and/or may be capable of so joining and/or mating), as described above. In some embodiments, the lid may be configured to cover and/or capable of covering a surface of a base portion of a device (e.g., a base portion of a device as described above).

In some embodiments, a method as described herein comprises applying makeup to a face of at least a portion of a plurality of protrusions of a device (e.g., a device as described above), such that the makeup is deposited on the face of the protrusions. In some embodiments, advantageously, the makeup applied to the face of the protrusions may be any of a variety of suitable makeup products, which may be chosen according to the preference of the user. The compatibility of the devices and methods described herein with a wide variety of suitable makeup products advantageously allows for the use of these devices and methods with makeup products having any suitable color and/or formulation, allowing the user greater control of the deposits of makeup applied to the skin (e.g., allowing the user to choose makeup products that may mimic the appearance of a natural arrangement of freckles on the user's skin).

In some embodiments, as noted above, a method as described herein comprises contacting at least a portion of a plurality of protrusions of a device (e.g., any device as described above) to the skin. In some embodiments, makeup is disposed on the faces of at least some of the protrusions. The method may comprise applying a pressure to a base portion of the device (e.g., the base portion of the device on which the plurality of protrusions are disposed) such that at least some of the makeup disposed on the face of the protrusions is transferred to the skin to form a deposit. In some embodiments, the amount of the makeup disposed on the face of the protrusions that is transferred to the skin may depend on a variety of factors. For example, in some embodiments, the amount of the makeup disposed on the face of the protrusions that is transferred to the skin may depend the magnitude of the pressure that is applied to the base portion of the device. In some embodiments, the dependence of the amount of makeup that is transferred to the skin on the pressure applied to the base portion of the device may advantageously allow for a user to have greater control over the amount of the makeup that is transferred to the skin, which may affect the appearance of the makeup deposits on the skin (e.g., by increasing and/or decreasing the level of pigmentation of the deposits, altering the size and/or distribution of the deposits, etc.). The user having greater control over the amount of the makeup that is transferred to the skin may allow for the user to alter the appearance of the deposits of makeup according to their preferences (e.g., by more accurately mimicking a naturally-occurring arrangement of freckles on the skin).

In some embodiments, a shape of a deposit of makeup that is transferred to the skin during the performance of a method described above (e.g., a deposit of makeup that is transferred to the skin from a face of one or more protrusions of a device as described above) may correspond to the shape of the face of the protrusions. For example, in some embodiments in which the face of the protrusions is substantially circular, the deposits of makeup on the skin may be substantially circular.

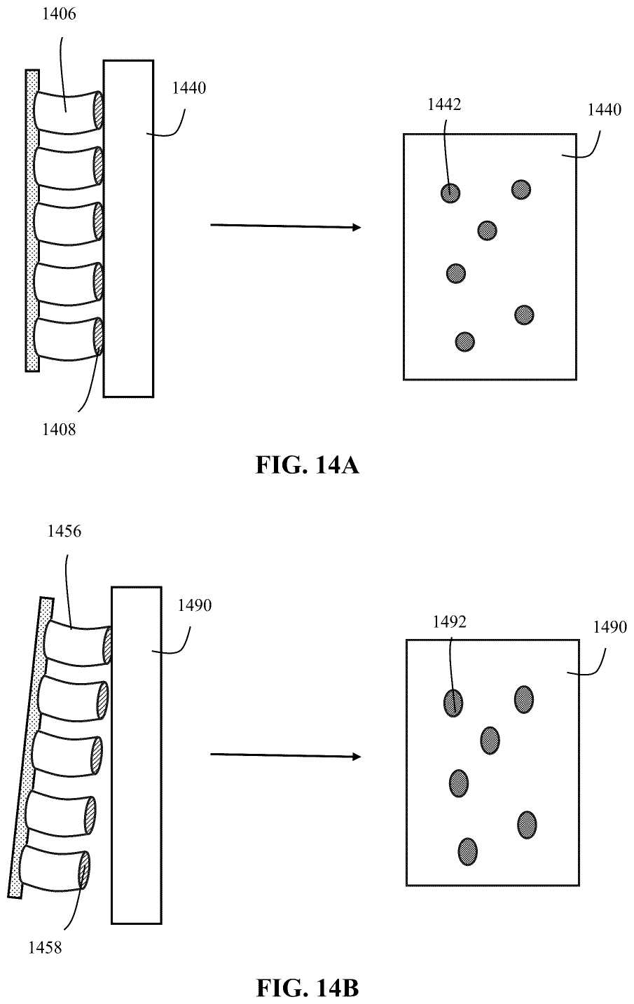

In some embodiments, a shape of a deposit of makeup that is transferred to the skin during the performance of a method described above (e.g., a deposit of makeup that is transferred to the skin from a face of one or more protrusions of a device as described above) may depend on an angle at which the protrusions are contacted with the skin. For example, in some embodiments, contacting the protrusions onto which makeup is disposed to the skin such that a face of the protrusions is substantially parallel to the skin may result in the shape of the deposits of makeup transferred to the skin corresponding directly to the shape of the face of the protrusions. For example, as shown in FIG. 14A, contacting protrusions 1406 to skin 1440 may result in the shape of deposits of makeup 1442 transferred to the skin corresponding directly to the shape of the faces 1408 of the protrusions 1406.

In some embodiments, contacting one or more protrusions of a device onto which makeup is disposed (e.g., as described above) to the skin such that a face of the protrusions is not substantially parallel to the skin (e.g., contacting protrusions 1456 to skin 1490 such that the face of the protrusions are at an angle to the skin, as shown in FIG. 14B) may result in the shape of the deposits of makeup 1492 transferred to the skin corresponding to a deformation of the shape of the faces 1458 of the protrusions 1456, such as an elongation of the shape of the face of the protrusions.

In some embodiments, a method as described herein may comprise applying makeup to the skin having any of a variety of suitable colors. For example, in some embodiments, the makeup may be brown. In some embodiments, the makeup may be black. In some embodiments, the makeup may have any of a variety of suitable colors and/or tones according to the preference of the user.

### Example Embodiment

This Example describes exemplary designs of certain freckle stamps.

Cosmetic trends continually evolve, with a recent emphasis on achieving a natural, freckled look. Existing methods for applying faux freckles and other skin irregularities often involve cumbersome and imprecise techniques. The proposed applicator device addresses these shortcomings by providing a user-friendly and versatile tool designed to mimic the appearance of natural irregularities in skin coloration such as freckles.

The proposed applicator device will provide a means of applying material deposits to the skin. Depending on the user's choice of material, these deposits will either emulate natural skin irregularities or create colorful but unnatural effects. The user can vary the effect by adjusting the angle of the applicator as well as the force with which they use it. The applicator device can be standalone or be mounted in a variety of casings or handles to provide convenient ergonomics.

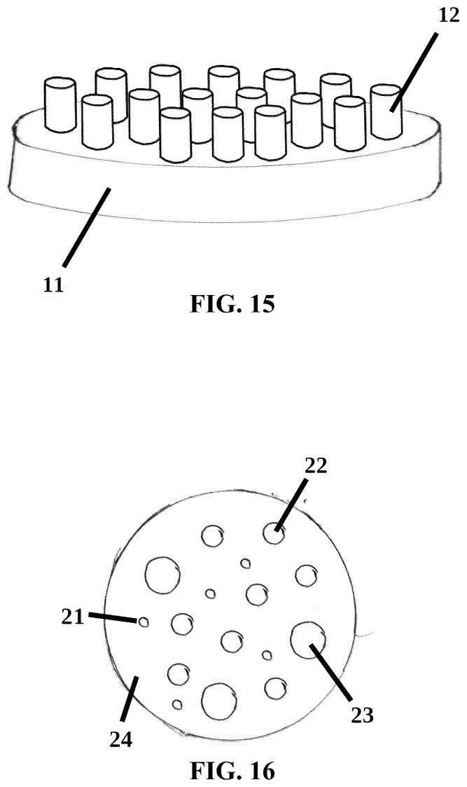

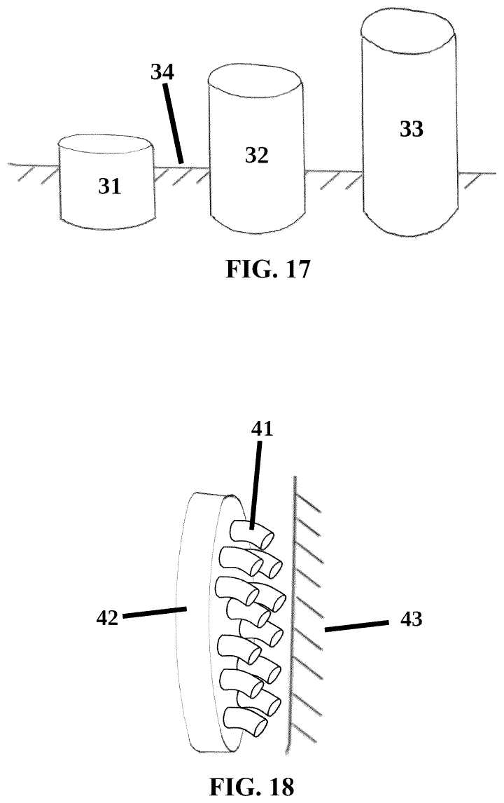

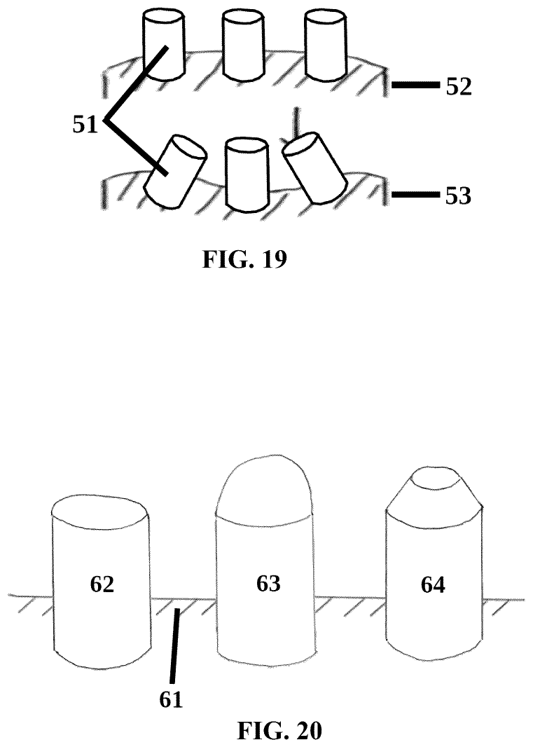

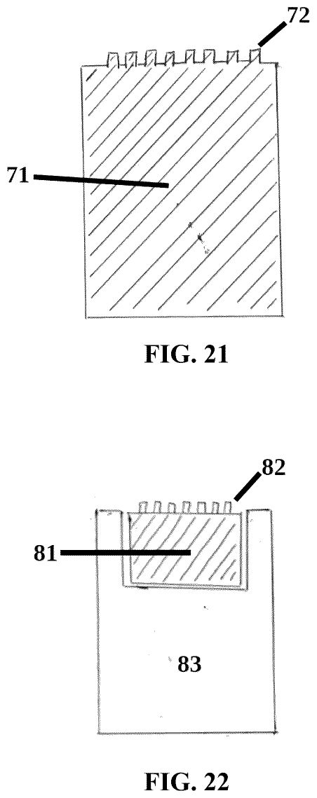

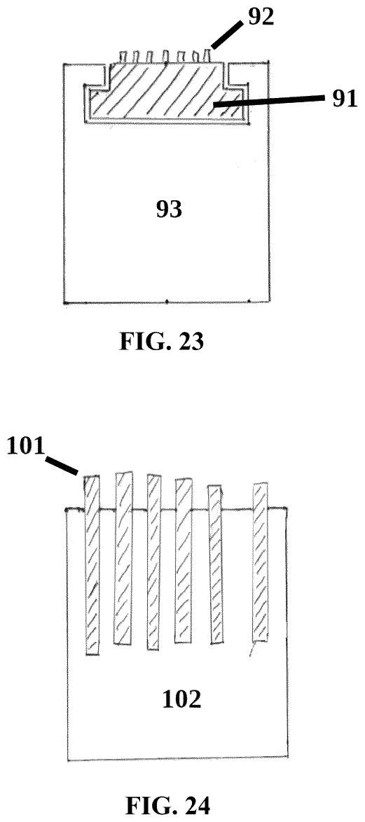

The applicator device consists of a pad with a plurality of small protrusions, shown in FIG. 15, upon which the user's material composition (e.g. makeup) is applied. The protrusions are arranged in a pseudo-random pattern and can optionally vary in width as shown in FIG. 16 and/or height as shown in FIG. 17. The applicator device is made out of a flexible, skin-safe material such that the device is able to make contact with the user's skin and not cause irritation. The flexible nature of the device causes the application of material to vary based on the pressure applied by the user. This variation is due to the following factors: the bending of the protrusions as shown by reference 41 and the deformation of the surface of the pad as shown in FIG. 19, both of which affect how the material is transferred from the applicator to the skin. As shown in FIG. 18 the user can further vary their results by tilting the device at an angle such that the faces of the protrusions touch the skin on their edges. To create unique effects at different tilt angles, we can vary the shape of the protrusion heads. This variation in the protrusion edges can be applied either within the same device or uniformly across different forms of the device. The first style of protrusion shown by reference 62 shows a squared edge, this creates a sharp and small deposit when used at an angle. The second style of protrusion shown in reference 63 has a rounded edge which produces a more elongated oval deposit when used at an angle. A third style of protrusion shown by reference 64 has its edge chamfered. This chamfering produces a smaller deposit than that of the standard applicator but applies uniformly. This combination of flexible deformation and protrusion head variation combined with imperfect user handling results in random effects that emulate natural irregularities in skin coloration. The pad to which the protrusions are anchored can be constructed in a multitude of configurations to allow for an ergonomic user experience. The first design is shown in FIG. 21 where the applicator is constructed as a single unit where the base extends to form a handle. The second design as shown in FIG. 22 where the applicator base is constructed as an insert and is press fit or chemically attached into position into a separate casing. The third configuration is shown in FIG. 23 where the applicator base is constructed as an insert that attaches to a handle or casing via a plug mechanism. The fourth configuration is shown in FIG. 24 where each protrusion acts as its own applicator device and a plurality are combined using any of the above attachment configurations to produce a similar pattern as shown in FIG. 16.

### OPERATION

1. User applies a material composition (e.g. makeup) to the surface of protrusions of the applicator device.
2. User lightly presses the applicator device against their skin.
3. Using their finger tips, a soft cloth or other soft tool the user lightly pats the deposits to remove excess material.
4. User repeats steps 1, 2 and 3 until desired deposits have formed.

### EXAMPLE DRAWINGS

FIG. 15. is a perspective view of the applicator device.

FIG. 16 shows a top-view of the applicator device.

FIG. 17. shows how protrusions can vary in height.

FIG. 18. shows how protrusions can be bent in angled usage.

FIG. 19. shows how protrusion pads can be deformed.

FIG. 20. shows protrusion variations.

FIG. 21. is a side cross-sectional view showing the applicator device with an extended base.

FIG. 22. is a side cross-sectional view showing the applicator device as an insert.

FIG. 23. is a side cross-sectional view showing the applicator device as a plug-style insert.

FIG. 24 is a side cross-sectional view showing a variation of how the device can be constructed from standalone protrusions.

### EXAMPLE REFERENCE NUMERALS

11 base pad
12 protrusion
21 small-width protrusion
22 medium-width protrusion
23 large-width protrusion
24 base pad
31 short protrusion
32 mid-height protrusion
33 tall protrusion
34 base pad
41 bent protrusion
42 base pad
43 surface where material is being applied
51 protrusion
52 base in steady-state position
53 base deforming under pressure
61 base pad
62 protrusion with squared edge
63 protrusion with rounded top
64 protrusion with chamfered edge
71 applicator device as a standalone unit
72 protrusion
81 applicator device as an insert
82 protrusion
83 ergonomic casing
91 applicator device as an plug insert
92 protrusion
93 ergonomic casing
101 standalone protrusion
102 ergonomic casing
   Paragraph 1: An applicator device comprising:
a flexible base
a plurality of protrusions whereby a user can apply material deposits to the surface of their skin.
   Paragraph 2: The system of Paragraph 1 including the following variations:
randomized protrusion location whereby the locations of the protrusions are changed to produce unique effects.
   Paragraph 3: The system of Paragraph 1 including the following variations:

randomized protrusion height whereby the height of the protrusions is varied to produce inconsistencies in the depositing of material. The variance in height will also affect the level of deformity that is experienced when applied with greater force.

Paragraph 4: The system of Paragraph 1 including the following variations:
randomized protrusion width whereby the width of the protrusions is varied to affect the diameter of the deposits.
   Paragraph 5: The system of Paragraph 1 including the following variations:
square protrusion edges whereby the walls of the protrusion form a 90 degree angle with the face. This creates a point when applied at an angle by the user producing a unique effect.
   Paragraph 6: The system of Paragraph 1 including the following variations:
rounded protrusion edges whereby the edges of the protrusion are rounded. This creates a continuous surface that can be rolled across different angles producing a unique effect.
   Paragraph 7: The system of Paragraph 1 including the following variations:
chamfered protrusion edges whereby the edges of the protrusion are chamfered. This creates a secondary surface that can be used at a discrete angle producing a unique effect.
   Paragraph 8: The system of Paragraph 1 including the following variations:
extension to the bottom face of the applicator pad whereby the base of the applicator device is extruded from the bottom to provide a body for the user to grip.
   Paragraph 9: The system of Paragraph 1 including the following variations:
friction-fit attachment to an ergonomic casing whereby the applicator device is attached within a cavity in a casing and held in place by a friction fit.
   Paragraph 10: The system of Paragraph 1 including the following variations:
chemical attachment to an ergonomic casing whereby the applicator device is attached to a casing via a chemical substrate.
   Paragraph 11: The system of Paragraph 1 including the following variations:
a brim is added to the applicator base forming a plug
an ergonomic casing with plug receptacle whereby a brim is added to the applicator base to allow it to sit flush inside a casing that has a cavity with an wider internal diameter. The applicator device acts as the connector and the casing as the receptacle.
   Paragraph 12: The system of Paragraph 11 including the following variations:
the applicator base containing a receptacle on its bottom face
an ergonomic casing with a connector plug on its top face whereby the attachment mechanism is the opposite of Paragraph 11.
   Paragraph 13: The system of Paragraph 1 including the following variations:
the applicator device is manufactured as a single object whereby the protrusions and base are a continuous structure.
   Paragraph 14: The system of Paragraph 1 including the following variations:
independent applicator protrusions
an ergonomic casing whereby individually manufactured protrusions are inserted into a casing that acts as the applicator base.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, device, article, material, kit, and/or method described herein. In addition, any combination of two or more such features, devices, articles, materials, kits, and/or methods, if such features, devices, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited. In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A device for applying makeup to skin, comprising:
a base portion comprising a surface; and
a plurality of protrusions disposed on the surface of the base portion, wherein:
each protrusion in the plurality of protrusions comprises a face,
an average height of the plurality of protrusions is greater than or equal to 1 mm and less than or equal to 2 mm, and
an average spacing between the protrusions is greater than or equal to 2 mm.

2. A method of applying makeup to skin, comprising:
contacting at least a portion the plurality of protrusions of the device of claim 1 to the skin, wherein the makeup is disposed on the faces of at least some of the protrusions; and
applying a pressure to the base portion of the device such that at least some of the makeup disposed on the face of the protrusions is transferred to the skin to form a deposit.

3. A device or method as in any preceding claim 1, wherein the protrusions are arranged to mimic an arrangement of freckles on skin.

4. A device as in claim 1, wherein the protrusions are arranged such that, when makeup deposited on the faces of the protrusions is transferred to the skin, the makeup mimics an arrangement of freckles on the skin.

5-6. (canceled)

7. A device as in claim 1, wherein the spacing between the protrusions is substantially random.

8.-11. (canceled)

12. A device as in claim 1, wherein the face of each protrusion in the plurality of protrusions is substantially circular in shape.

13. (canceled)

14. A device as in claim 1, wherein one or more protrusions in the plurality of protrusions is a tapered protrusion.

15. (canceled)

16. A device as in claim 1, wherein one or more protrusions in the plurality of protrusions comprises a chamfered edge.

17. (canceled)

18. A device as in claim 1, wherein the face of one or more protrusions in the plurality of protrusions is substantially flat.

19. A device as in claim 1, wherein the face of one or more protrusions in the plurality of protrusions is rounded.

20-23. (canceled)

24. A device as in any claim 1, wherein the protrusions and/or the base portion are formed from thermoplastic polyurethane.

25. A device as in claim 1, wherein the protrusions and the base portion are co-formed from a single material.

26. A device as in claim 1, wherein the protrusions and/or the base portion are 3D-printed.

27. A device as in claim 1, wherein the protrusions and/or the base portion are formed from a porous material.

28. A device as in claim 1, wherein the protrusions and/or the base portion are formed from a flexible material.

29-31. (canceled)

32. A device as in claim 1, further comprising a casing configured to support and/or contain at least a portion of the base portion of the device.

33. A device as in claim 32, wherein the casing comprises a cavity configured to hold the base portion of the device.

34. A device as in claim 33, wherein the base portion of the device is press-fit and/or friction-fit into the cavity of the casing.

35. A device as in claim 33, wherein the base portion of the device is secured within the cavity of the casing chemically and/or mechanically.

36. (canceled)

37. A device as in claim 32, wherein the casing and the base portion of the device are co-formed from a single material.

38-43. (canceled)
